(19) United States
(12) Patent Application Publication
(10) Pub. No.: US 2003/0177376 A1
(43) Pub. Date: Sep. 18, 2003

(54) Framework for maintaining information security in computer networks

(75) Inventors: Ivan Francisco Fernando Arce Velleggia, Buenos Aires (AR); Ariel Futoransky, Buenos Aires (AR); Gerardo Gabriel Richarte, Buenos Aires (AR); Emiliano Kargieman, Buenos Aires (AR); Carlos Hernan Ochoa, Buenos Aires (AR)

Correspondence Address: FITZPATRICK CELLA HARPER & SCINTO, 30 ROCKEFELLER PLAZA, NEW YORK, NY, 10112, US

(73) Assignee: Core SDI, Inc., Boston, MA (US)

(21) Appl. No.: 10/354,568

(22) Filed: Jan. 30, 2003

Related U.S. Application Data
(60) Provisional application No. 60/352,824, filed on Jan. 30, 2002.

(51) Int. Cl. H04L 9/32

(52) U.S. Cl. 713/189

(57) ABSTRACT

A system is provided for controlling access to information technology assets in a computer network. The system includes a ticket manager server configured to generate tickets based on user data in a master database. A ticket manager client, resident on a workstation, is configured to receive tickets from the ticket manager server and distribute resource data obtained from the tickets to network security modules. The user data includes resource registers, each of which has a type field designating a particular security module, resource data for use by the designated security module, and an execution domain field that exclusively designates an execution environment in which the designated security module can use the resource data.

This application claims the benefit of U.S. Provisional Application No. 60/352,824, filed Jan. 30, 2002.

### BACKGROUND OF THE INVENTION

1. Field of the Invention

The present invention relates generally to maintaining information security for information technology assets in computer networks. More specifically, the invention relates to a security framework that allows information security modules to interact with one another to provide a systematic, integrated information security solution.

2. Related Art

In the last two decades, society has experienced an explosive development of information technology and its application, in both the corporate and governmental sectors. Computer systems and computer networks are being used to store and manipulate large concentrations of important information and are replacing paper as the principal platform for the operations of reasonably-sized organizations. However, the associated boom in communications, the trend towards open systems, and the establishment of the Internet as a pervasive communication medium all have created an environment in which the risks associated with the critical nature of these computer networks and the profusion of threats to information stored on such networks can hinder the complete development of these new technologies.

Thus, information security plays an important role in the assessment of the technical risks associated with any significant corporate project. There is therefore a growing need for and reliance upon information security systems, and professionals capable of implementing such systems. Two important obstacles to overcome in providing effective information security are the operative difficulties inherent in integrating conventional tools for information security and the heterogeneous nature of computer system technology.

A diverse variety of tools for information security have proliferated in response to this need. These tools, however, typically have been oriented toward the resolution of specific security problems and have not addressed the overarching structural aspects of information security in a systematic way. This lack of a systematic approach has resulted in information security systems that possess only a limited capacity to work in an integrated fashion, which hinders the efforts of organizations to protect their information effectively.

Compounding the problems arising from the lack of a systematic approach to information security are the complications caused by the heterogeneous nature of the technology underlying typical computer networks. Many organizations have computer system infrastructures that are the result of more than two decades of evolution within the organization and that have been influenced by the requirements of divergent and independent projects and the availability and acquisition of new technology. Thus, these organizations accumulate a diverse technological legacy, which may include: hardware such as mainframes, Unix work stations, and personal computers; operating systems such as Windows 3.x, Windows 9x, and Windows NT, Windows 2000, and Windows XP; and networks with IPX and TCP/IP protocols and Ethernet/token ring configurations.

Due to this heterogeneity of existing computer networks, the functions of information security systems, such as the management of security policies through user controls and auditing, are divided among the various interfaces, conventions, and formats of diverse computer system platforms. This compartmentalization of information security functionality weakens overall computer system security and leads to an inefficient use of computer system and professional resources. For example, it is common for security weaknesses found in a specific platform to appear later in other platforms used by an organization. As a further example, a simple auditing operation to identify the resources to which a particular user has access might involve a number of different administrators and/or auditors for the various diverse platforms in the computer system and may take days to obtain minimally satisfactory results.

The use of conventional information security tools in the technological environment described above may lead to a number of different information security vulnerabilities, each of which may expose the organization to a varying degree of risk. Many of these vulnerabilities relate to workstations (such as for example a typical user's desktop computer). For example, unlike servers, which typically are located in a centralized computing center and have access control measures, workstations may be physically dispersed throughout an organization and may not have access control measures. Thus, workstations are potential subject to various types of attacks due to both a lack of appropriate access control mechanisms and their physical exposure to unauthorized users.

In addition, workstations may lack resource access control, thereby allowing users to indiscriminately access, execute, and modify all available resources, which can contribute to information security vulnerabilities and the spread of information viruses. Furthermore, many of the commonly-used operating systems such as DOS, Windows 3x, and Windows 9x, do not incorporate mechanisms that provide adequate protection of the resources and processes with which the workstation operates.

Another security vulnerability relating to workstations arises from the fact that client/server systems often delegate a large part of the authentication and validation processes to the client component, i.e., the workstation. As a consequence, users are often free to use tools or applications which do not implement the validations necessary in order to guarantee proper access control and information integrity. For example, an organization may use a client-based application that provides proper authentication and validation in accessing a database on the server, but a workstation may be used to run an unauthorized application that accesses the database without the proper controls.

In addition to these workstation-related information security vulnerabilities, there are many vulnerabilities associated with computer network communications. For example, network-level communications of local area networks (LANs) typically use network protocols, such as TCP/IP and IPX, that do not include encryption capabilities. While there are ways to encrypt such connections, these tend to be ad hoc solutions, and it is generally the case that network communications can be intercepted using readily available tools. As a further example, access control policies based on access point are susceptible to attacks of falsified accreditation. In general, the precautions taken by network protocols to prevent such attacks are insufficient, and attacks that exploit this vulnerability are readily available.

Another communication-related vulnerability arises in user-authentication procedures, which may involve for example the exchange of a password. These procedures may be susceptible to being compromised by attackers who can access passwords by intercepting (i.e., sniffing) network traffic, thereby rendering useless the authentication procedures. Similarly, network protocols include capabilities for insuring the integrity of communications, but a determined attacker with access to the network can falsify messages sent in a previously authenticated session, in what is referred to as a replay-attack.

Another well-known, commonly used type of attack takes advantage of the availability of services offered by the computer network. Such attacks take advantage of the vulnerabilities in the implementation of network protocols and of the services in question. For example, it is possible to flood a service with information, thereby saturating its processing capacity and rendering it unavailable to legitimate users.

Other information security vulnerabilities relate to the server or servers of a computer network, which are particularly targeted by attackers, because they store a concentration of the organization's important information. The server base software, which provides the basic functionality of a server, may have vulnerabilities that allow unauthorized access to server data. For example, the base software may be misconfigured so as to allow a user with an improper level of privilege to access sensitive functions of the server. Adaptive modification activities, which include the implementation of application patches in response to detected security vulnerabilities, are a vital part of maintaining information security, but are not necessarily present in conventional solutions. There are some conventional security strategies that offer a single line of defense against server attacks. However, an attacker who manages to penetrate this security mechanism then would have complete access to the protected resources of the server.

Another server-related vulnerability arises from the fact that the auditing functions of the most commonly used servers are based on standard access control facilities. Under these conditions, a successful intrusion will also allow access to auditing registers, which means that an attacker could alter the security logs to hide any record of the intrusion. In addition, most commonly-used operating systems do not distinguish between the roles of security administrator and product administrator. As a result, and due to operational reasons, both the product administrator and the security administrator have unrestricted access to the server being administered, which may make implementation of security policies more difficult.

Conventional approaches to information security, which are described below, tend to be stand-alone solutions to specific problems. Such approaches have limited effectiveness and efficiency compared to a systematic, integrated solution.

The firewall is one of the most popular of these information security tools. Firewalls permit the establishment of access control mechanisms on the network level, allow isolation of specific segments of the network through certain rules, and control of the flow of information between them. Typically, access control policies are configured based on source and destination network addresses of the computers involved in the network communications. Some firewalls also have tools that allow for the direct authentication of users as a complement to the authorization performed by the workstation. Firewalls, however, are generally used to enforce security policy at the perimeter, or edge, of a network and do not address the security issues that arise within a secured network. Moreover, a specialized configuration is required to implement security procedures, and the management of multiple firewalls deployed across an organization's network can be cumbersome and expensive.

Another conventional approach to information security is the use of hardware-based encryption to assure the confidentiality of network communications. However, the cost of these components is relatively high, especially considering the number of network links to be protected in larger computer networks. Each network connection requires the installation of two components, one for each end of the connection, and the components only provide confidentiality for the specific connection on which they are installed. These components also must be installed and configured, which results in further costs. Moreover, most products of this type do not include the tools necessary to adjust the algorithms or protocols they use in response to a changing security environment. In addition, hardware-based encryption devices often require extensive key-management support for the encryption keys used by the devices, and these keys ordinarily cannot be used for other purposes or in other modules.

Single sign-on is an information security tool that allows users to sign in once with a single user identification and password and have access to a group of protected resources. Single sign-on makes it more convenient for users to access the protected resources, as there would otherwise be a separate sign-on procedure for each resource. While single sign-on solutions are readily available, the administrative efforts associated with their implementation weighs against the potential benefits. Conventional single sign-on solutions construct a platform that allows for the simple verification of a user's credentials and permission. However, any applications developed prior to the incorporation of the single sign-on platform would not be included in the single sign-on process unless the applications are modified at the source code level or specialized software components are deployed to achieve an integrated single sign-on solution.

Intrusion detection systems can be a useful information security tool in constructing various lines of defense. It is very difficult, however, to adapt conventional intrusion detection systems to detect particular circumstances with respect to the organizational environment. Furthermore, complications often arise when trying to coordinate the operation of these systems with that of other security tools.

In general, there are a number of information security tools available to reduce the security vulnerabilities discussed above, such as products that provide auditing capabilities, line encryption of sensitive information, and the configuration of access permits for files and users. However, these tools fail to provide a centralized, fully integrated protection system that allows for the flexible configuration of access permits. The tools also fail to address the emerging security characteristics of an information system, i.e., the security properties that arise from the interaction of distinct, complex, security subsystems. In addition, the complexity of the administrative and security modules associated with day-to-day work activities and the number of independent security tools with which the user must work reduce the level efficiency of conventional information security systems. Thus, the tools and technologies available to information security practitioners limits them to implementing reactive security practices centered around the deployment of software and hardware solutions that act upon existing flaws and security incidents, as opposed to a more modern approach based on proactive measures to prevent security incidents and reduce the risk associated with them before they occur, and to address information security issues in an organization as part of its strategy to achieve success

In view of the shortcomings discussed above, there is a need for a system and method for maintaining information security for information technology assets that overcomes the drawbacks of the conventional technologies by providing a security framework sub-system for distributing and controlling specific information security modules with context information to form an overall security framework.

### SUMMARY OF THE INVENTION

The present invention generally provides a novel system, method, and computer code for controlling access to information technology assets in a computer network.

In one aspect of the present invention, a ticket manager server is configured to generate tickets based on user data in a master database. A ticket manager client, resident on a workstation, is configured to receive tickets from the ticket manager server and distribute resource data obtained from the tickets to network security modules. The user data includes resource registers, each of which includes a type field designating one of the security modules, resource data for use by the designated security module, and an execution domain field that exclusively designates an execution environment in which the designated security module can use the resource data.

Embodiments of this aspect may include one or more of the following features. The user data may include user registers that each correspond to a user and profile registers that each correspond to one or more users. The system may allow each user register and each profile register to be associated with one or more resource registers.

The ticket manager server may generate a ticket for a user by searching the master database for a register for the user, separating the register into resource references and profile references, adding the referenced resources to the ticket, adding the referenced profiles to a local tree, and traversing the local tree using a breadth-first search algorithm. Under that algorithm, the resources associated with each profile are added to the ticket starting at a first branch level of the local tree and proceeding to sub-branch levels, if any.

In other embodiments of this aspect of the invention, the designated security module may be a module for providing single sign-on capability, and the resource data may include user authentication credentials including, but not limited to, user name and user password data. The designated security module may be a module for establishing logical access control for information stored in the computer network, and the resource data may include file access parameters. The designated security module may be a module for providing encrypted communication between components of the computer network, and the resource data may include encryption configuration information. The designated security module may be a module for controlling a computer network administrative procedure by defining nodes that represent steps that are performed in the procedure, and the resource data may include a designated type of user that is authorized to complete each node. The designated security module may be a module for controlling generation of a network log, and the resource data may include parameters relating to criteria for logging information and users to be included in the log. The designated security module may be a module for providing content-based control over transactions in the computer network, and the resource data may include parameters relating to criteria for network transactions that are to be controlled.

In another aspect of the invention, a ticket manager server is configured to generate tickets based on user data in a master database. Ticket manager clients, each resident on a workstation, are configured to receive tickets from the ticket manager server and distribute resource data obtained from the tickets to network security modules. Local ticket manager slave databases, each resident on one of the workstations, and configured to receive a copy of each of the tickets sent to a corresponding one of the ticket manager clients. A global ticket manager slave database is configured to receive a copy of each of the tickets sent to the ticket manager clients. In embodiments of this aspect of the invention, the system may include a mirror ticket manager server configured to generate tickets based on user data in a mirror database that is periodically copied from the master database of the ticket manager server.

In another aspect of the invention, a ticket request is received at a ticket manager server that has user data in a master database. A ticket is created for the user containing resource data for use by network security modules. A user register corresponding to the user is retrieved from the master database. It may be determined whether the user register refers to any resource registers. If so, the referenced resource registers are retrieved from the master database and any resource data in the retrieved resource registers is added to the ticket. The ticket is output from the ticket manager server in accordance with the ticket request.

Embodiments of this aspect of the invention may include one or more of the following features. It may be determined whether the user register refers to any profile registers. If so, the referenced profile registers are retrieved from the master database. It may be determined whether each of the referenced profile registers refers to any resource registers. If so, the referenced resource registers are retrieved from the master database and any resource data in the retrieved resource registers is added to the ticket. It may be determined whether each of the referenced profile registers refers to any sub-profile registers. If so, the referenced sub-profile registers may be retrieved from the master database. It may be determined whether each of the referenced sub-profile registers refers to any resource registers. If so, the referenced resource registers may be retrieved from the master database and any resource data in the retrieved resource registers may be added to the ticket.

In another aspect of the invention, a ticket is requested from a ticket manager server. A ticket is generated by retrieving from a master database a user register, retrieving any referenced resource registers, and adding any resource data in the retrieved resource registers to the ticket. The ticket is sent to a ticket manager client in a workstation. The resource data is retrieved from the ticket and distributed to network security modules.

Embodiments of this aspect of the invention may include one or more of the following features. Updated resource data may be added to the ticket in the ticket manager client. The updated ticket may be sent to the ticket manager server. The updated resource data may be retrieved from the ticket and stored in the master database. The ticket may be digitally signed after generating the ticket, and the ticket manager client may authenticate the ticket after it is received.

These and other objects, features and advantages will be apparent from the following description of the preferred embodiments of the present invention.

### BRIEF DESCRIPTION OF THE DRAWINGS

The present invention will be more readily understood from a detailed description of the preferred embodiments taken in conjunction with the following figures.

FIG. 1 is a block diagram of a system for maintaining information security in a computer network in accordance with the present invention.

FIG. 2 is a block diagram of the information security modules and the Ticket Management Sub-system.

FIG. 3 is a block diagram of the redundant ticket circulation configuration of the Ticket Management Sub-system.

FIG. 4 is a block diagram of the user log-on and ticket circulation procedures.

FIG. 5 is a block diagram of the ticket circulation contingency procedures.

FIG. 6 is a block diagram showing an example of a relationship between users, profiles, and resources.

FIG. 7 is a block diagram of the Ticket Manager Master Database.

FIG. 8 is a block diagram of a user register in the TM Master Database that refers to a profile register and a policy register.

FIG. 9 is a block diagram of a profile register in the TM Master Database that refers to a policy register.

FIG. 10 is a block diagram of a user register in the TM Master Database that refers to a Single Sign-on resource.

FIG. 11 is a block diagram of a profile register in the TM Master Database that refers to a WSO resource.

FIG. 12 is a screen image of a graphical user interface for the Resource Administrator.

### DETAILED DESCRIPTION OF THE PREFERRED EMBODIMENTS

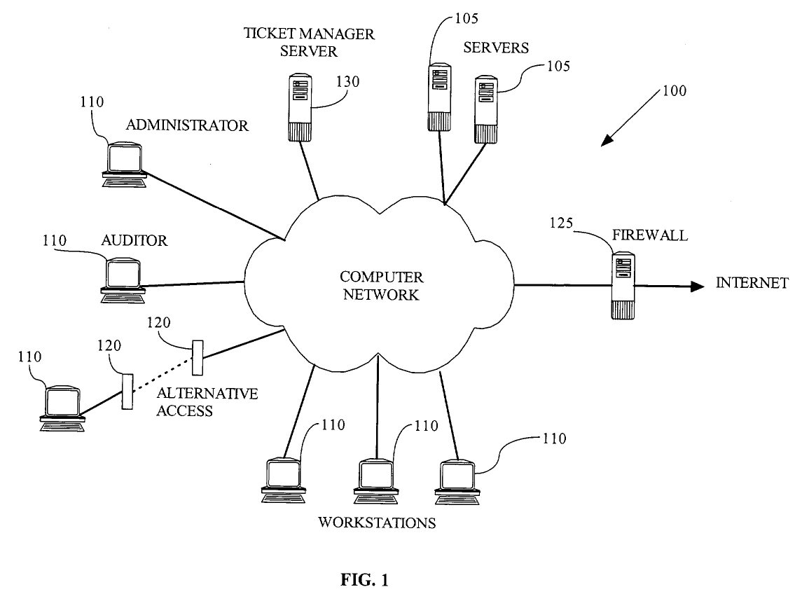

According to the present invention, as shown in FIG. 1, an integrated security framework is provided for a computer network 1. The network includes a number of servers 105, which are computers configured to provide network services, such as mainframe computers, minicomputers running Unix, and personal computers running Windows operating systems. The servers are connected to a number of workstations 110, which may be any device that provides a point of access for users, such as a personal computer or a terminal. The network may be implemented using, for example, IPX/TCPIP protocol and Ethernet or Token Ring configurations. The network may include workstations that access the network remotely, such as a personal computer 115 using a dial-up modem 120. The network also may include an Internet connection through a firewall 125, which is a security device that handles Internet traffic to and from the network and serves to protect the network from unauthorized access.

As part of the integrated security framework, a Ticket Manager Server (TM Server) 130 maintains a database of context information for each user that controls the manner and extent to which the user may access the information technology (IT) assets. Information technology assets is a broad term that covers both software residing in the network, e.g., data and applications, and hardware connected to the network, e.g., printers, input/output devices, and network interfaces. The context information is distributed to various information security modules throughout the network by a Ticket Management Sub-system. As discussed below in detail, the information security modules perform various security-related functions and interact with one another based on the context information. For example, the workstations 110 may incorporate a logical access control structure that restricts the user's access to information stored on network devices. When the user logs on to the network, the workstation 110 requests context information from the TM Server 130 that includes information regarding the access restrictions for that particular user.

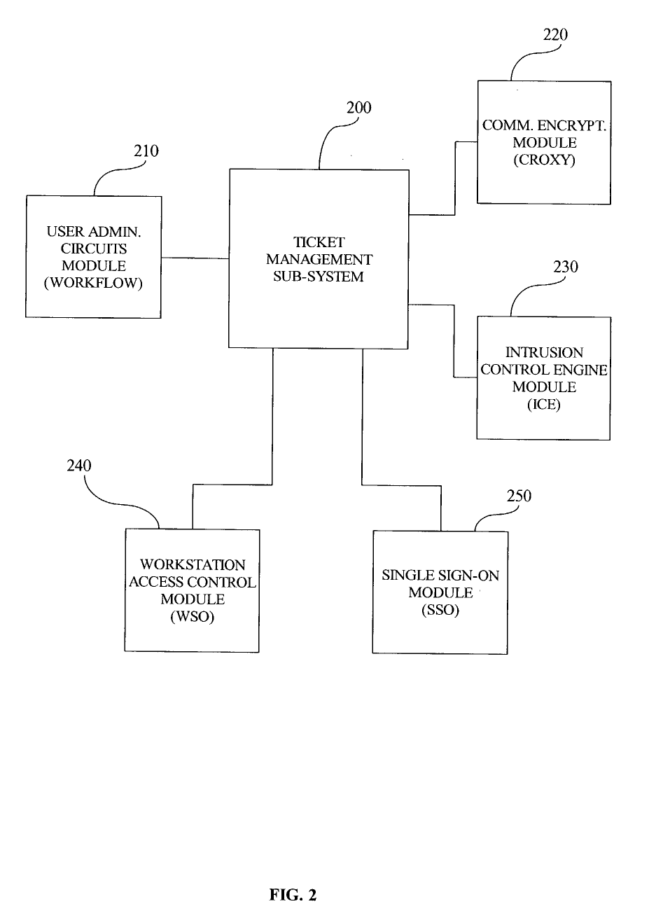

In the example of FIG. 2, the Ticket Management Sub-system 2 that interacts with five security modules: User Administration Circuits Module (Workflow) 210, Communication Encryption Module (Croxy) 220, Intrusion Control Engine Module (ICE) 230, Workstation Access Control Module (WSO) 240, and the Single Sign-on Module (SSO) 250. The Ticket Management Sub-system 2 organizes the context information into data structures referred to as tickets and distributes and controls the exchange of the tickets between the modules. Each security module is configured to use the tickets as a source of data and/or parameters to implement and control the security functions for which the module is responsible. As further discussed below, the tickets are distributed to local clients that in turn communicate with the modules to distribute the security parameters and data. These clients in effect form a distributed database in which the tickets are the means for distributing information between the nodes (i.e., user workstations 110) of the database.

The security modules described herein serve as illustrative examples of the various types of security modules that can be integrated in the security framework. In practice, any module capable of accepting context information may be included in the security framework, such as firewalls, operating system access control mechanisms, application security mechanisms, etc.

The User Administration Circuits Module (Workflow) 210 controls user administration procedures by defining a workflow circuit to represent each procedure. The workflow circuit is a series of stages or nodes that correspond to steps that are performed in the administrative procedure. The Workflow Module allows the definition of roles (e.g., product administrator, information security officer, security administrator, auditor, etc.) that are authorized to complete each node of the workflow circuit and advance to the next node. The Workflow Module uses tickets to determine the various levels of permission that each user has with respect to performing each node in the workflow circuits.

For example, the modification of a user's profile, which defines the set of information technology assets available to the user, is an administrative procedure that is definable as a workflow circuit. As an initial step, the user's supervisor may request a modification to the user's profile. This request may be subject to the approval of a human resources director, who verifies that the profile modification is consistent with the user's role within the organization. The request then may be subject to approval by an information security officer, who determines whether the permissions or restrictions assigned to the profile requested for this specific user comply with the organization's security policy. Finally, the request may be implemented by a security administrator or automatically implemented by the system. Each of these steps forms a node of a workflow circuit and may only be implemented by the specific role, e.g., information security officer, designated to perform that function.

The Communication Encryption Module (Croxy) 220 provides encrypted communication between the workstations and network components known as encryption gateways by implementing the Internet Protocol Security Standard (IPSec), as defined by the Internet Engineering Task Force (IETF). The Croxy Module may implement both software-based and hardware-based encryption. The Croxy module uses tickets to obtain the configuration information, e.g., key information, necessary to implement the encrypted links between the workstations and encryption gateways.

The Intrusion Control Engine Module (ICE) 230 controls the generation of network logs, which are databases that accumulate data relating to network communications and transactions to allow auditing by security administrators. The ICE Module may be configured to log information based on criteria such as the originating user or class of user, originating application or service, originating execution domain, time of day, destination server address or service, or content of the network communication (e.g., log only instances of specific communications, such as queries to a particular database that contains sensitive information). The module also may be configured to log a transcript of an entire network session for a particular user or class of user. The ICE Module uses tickets to determine the parameters of each log and the particular users or class of user affected by the log. The ICE Module also provides content-based control over network transactions. The module examines the content of each network transaction and can stop transactions or close network connections based on criteria such as those discussed above. The ICE Module uses parameters contained in tickets to define the types of network transactions that are to be monitored and/or controlled.

The Workstation Access Control Module (WSO) 240 establishes a logical access control structure that allows access to the information stored in workstations and servers to be restricted according to specific users, classes of users, and/or predetermined security policies. For example, the module allows for the specification of access characteristics for specific files and/or file directories, such as read-only access. Access characteristics also may be specified for registry configuration information and network devices, such as printers, etc. As further discussed below, the WSO in conjunction with the Ticket Management Sub-system may be used to specify access characteristics for the execution of specific programs based on the execution domain. The WSO Module uses tickets to determine the extent of access each user has to the information technology assets.

The Single Sign-on (SSO) Module 250 functions with the interfaces that applications and services use to identify users. When an application solicits a password or user-name, the SSO Module automatically enters the information. This allows the user to be automatically authenticated in a variety of applications without remembering and entering multiple usernames and passwords. The SSO Module uses tickets as a data source for usernames and passwords for each user for each particular application.

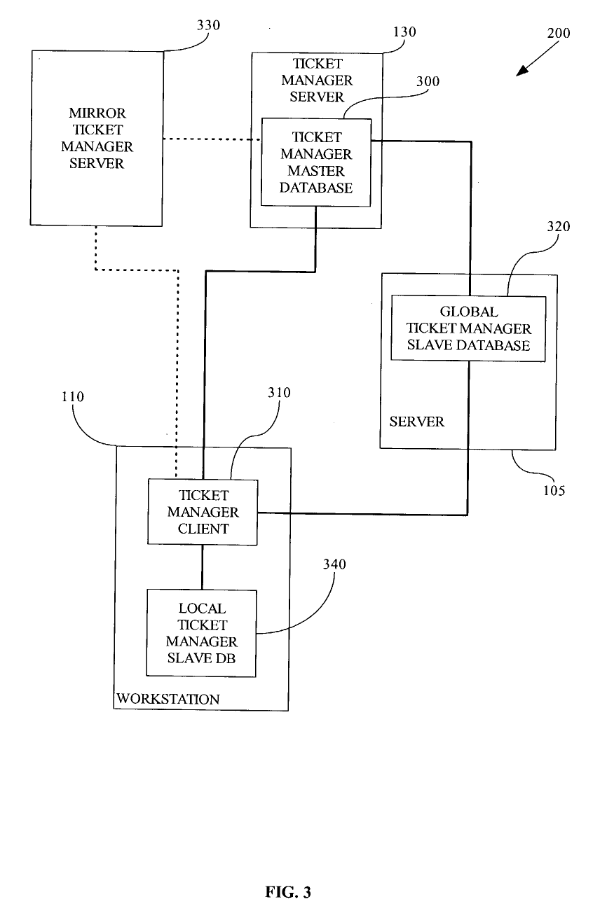

By functioning as the carrier of data and parameters to the security modules discussed above, the tickets form an important part of the security framework. As shown in FIG. 3, the tickets are circulated through the network using a system having redundancy in order to maintain high system availability. Tickets are generated by a Ticket Manager Server (TM Server) 130, which stores the data used to form the tickets in a TM Master Database 300. The Ticket Management Sub-system 200 delivers the tickets to a TM Client 310 in the user's workstation 110, which supplies the data provided by the ticket to the information security modules discussed above.

In this example, the Ticket Manager Server (TM Server) 130 is a standalone server that is separate from the main network servers 105. This configuration allows workstation users to receive a ticket even if the network server cannot be accessed. In addition, a copy of the tickets generated by the TM Master Database 300 is stored in the Global TM Slave Database 320, which is maintained on the network server 105. Updated tickets received by the TM Server 130 from the workstations 110, as described below, also are stored in the Global TM Slave Database 320. This configuration allows workstation users to receive tickets even if the TM Server 130 cannot be accessed. Alternatively, the TM Server 130 may be implemented within one of the network servers 105, rather than as a separate server. In such a case, the TM Master Database 3 and the Global TM Slave Database 320 would both be located on one of the network servers 105, or the Global TM Slave Database 320 may be omitted. However, the use of a stand-alone TM Server 130 is preferred, as it provides greater redundancy.

One or more mirror servers 330 may be provided for the TM Server 130. The Mirror TM Servers 330 copy data from the TM Server 130 periodically to maintain a copy of the master database 300 that can be accessed in the event of a failure of the TM Server 130. Another level of redundancy is provided in the workstation itself 110, which maintains Local TM Slave Database 340. As the ticket data is stored or updated in the TM Master Database 300, corresponding changes are made in the Local TM Slave Database 340. This configuration allows workstation users to receive tickets even if the TM Server 130, Mirror TM Server 330, and the network servers 105 cannot be accessed.

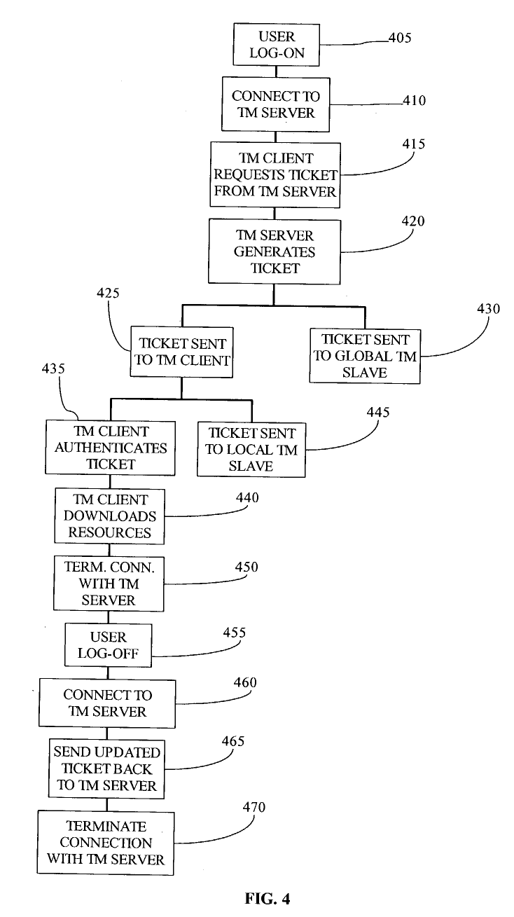

FIG. 4 shows the sequence for the circulation of tickets when a user logs on to a workstation 110. After the user log-on (step 405), a connection is established (step 410) to the TM Server 130, and the TM Client 310 requests a ticket for the user (step 415). The TM Server 130 generates the ticket (step 420) based on the information stored in the TM Master Database 300 and sends the ticket (step 425) to the TM Client 310. A copy of the ticket is sent (step 430) to the Global TM Slave Database 320 on the network server 105. The TM Client 310 authenticates the ticket (step 435), which is signed with a digital signature by the TM Server 130, and downloads the data and parameters contained in the ticket (step 440) for use by the information security modules. The TM Client 310 also sends a copy of the ticket (step 445) to the Local TM Slave Database 340 on the workstation 110. The connection to the TM Server 130 is terminated (step 450).

Certain information on the ticket may change during the user's session. For example, the user may change password information that is used by the Single Sign-on Module. When the user logs off (step 455), the TM Client 310 establishes a new connection (step 460) with the TM Server 130 and sends an updated ticket back (step 465) to the TM Server 130 and to the Local TM Slave Database 340. The connection with the TM Server 130 is terminated (step 470). The TM Server 130 then passes the updated information to the Global TM Slave Database 320 on the network server 105.

To optimize the ticket data circulation process, the ticket information may be transferred to and from the various redundant databases by transmitting only that portion of the ticket information that has changed. The TM client 310 uses a time-stamping mechanism to request only those portions that have expired or have been modified since the last transmission. The TM Server 130 maintains a master clock for the system that stamps the time of creation or modification of the ticket information. The master clock cannot be modified by users, including system and product administrators. To maintain security, the digital signature exchanged with the ticket information refers to the entire ticket, rather than just the updated information.

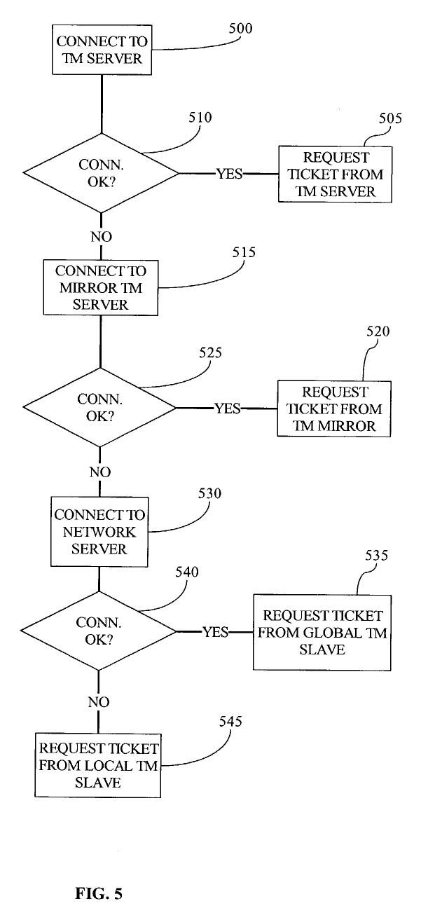

FIG. 5 shows the contingency sequence that is followed when the workstation is unable to connect to the various redundant sources of ticket information. First, the TM Client 310 attempts to connect (step 5) to the TM Server 130 request a ticket (step 505). If a connection cannot be established (step 510) to TM Server 130, then the TM Client 310 attempts to connect (step 515) to a Mirror TM Server 330 to request a ticket (step 520). Similarly, if a connection cannot be established (step 525) to a Mirror TM Server 330, then the TM Client 310 attempts to connect (step 530) to the network server 105 to request a ticket (step 535) from the Global TM Slave Database 320. Finally, if a connection cannot be established (step 540) to the network server 105, then the TM Client 310 requests a ticket (step 545) from the Local TM Slave Database 340 on the workstation 110.

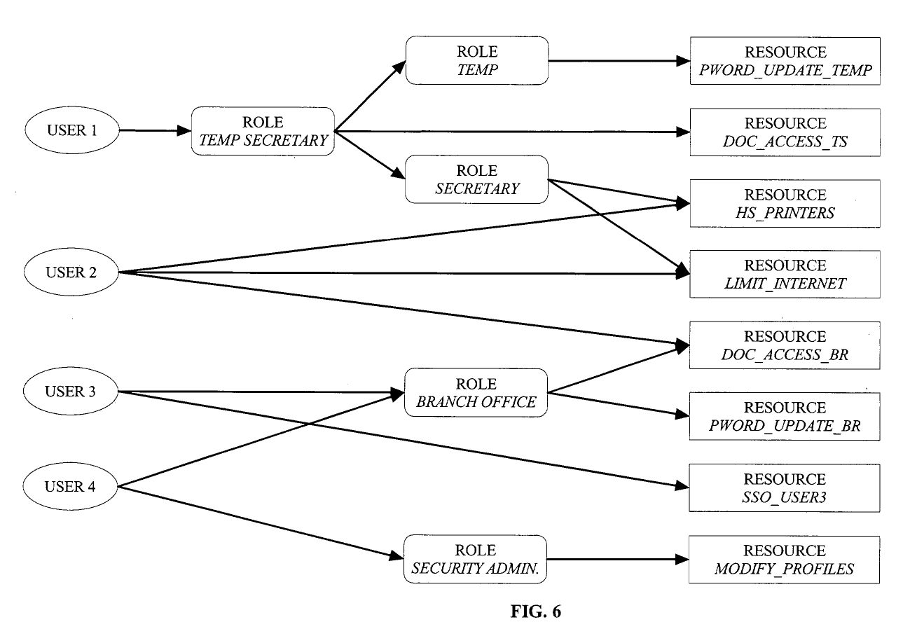

The context information contained in each user's ticket is used to control access to the information technology assets according to a role-based access control model. As shown in FIG. 6, under the role-based access control model, users may be assigned to particular roles, which relate to the function performed by that user within the organization or other criteria, such as geographic location, level of authority, rank, security clearance, and/or official position. Each role, which may also be referred to as a profile, is associated with particular resources. In this context, a resource is a set of parameters and/or data that is used by a security module to control access to an information technology asset. For example, the resource called “SSO_USER3” provides password data for a particular user for use by the single sign-on module, “HS_PRINTERS” provides access to high-speed printers connected to the network, “DOC_ACCESS_TS” provides access to particular documents stored on the network.

In the example of FIG. 6, USER 1 is associated with the role of TEMP SECRETARY, which is used to define a set of resources relating to temporary secretaries. This role is associated with the resource DOC_ACCESS_TS, which is a set of parameters configured to allow access to particular documents on the network using the Workstation Access Control Module. The TEMP SECRETARY role itself is associated with two additional roles, which may be referred to as sub-roles: TEMP (relating to temporary employees) and SECRETARY (relating to secretaries). Each of these sub-roles is in turn associated with particular resources. The role TEMP is associated with resource PWORD_UPDATE_TEMP (defining the frequency with which the user's password must be updated), and the role SECRETARY is associated with resources HS_PRINTERS (allowing access to high-speed printers) and LIMIT_INTERNET (limiting access to the Internet).

Referring further to the example of FIG. 6, USER 2 is directly associated with three resources: HS_PRINTERS, LIMIT_INTERNET, and DOC_ACCESS_BR (providing access to documents stored in the server for the branch office). Associating a user directly with particular resources may be helpful for users with unique access requirements. USER 3 is associated with role BRANCH OFFICE (defining requirements for the branch Office) and SSO_USER3 (providing password information for the Single Sign-on Module). Role BRANCH OFFICE is in turn associated with DOC_ACCESS_BR and PWORD_UPDATE_BR (defining the frequency with which the user passwords must be updated in the branch office). USER 4 is also associated with role BRANCH OFFICE and is also associated with the role SECURITY ADMIN. The role of SECURITY ADMIN is configured to allow the security administrator to perform certain tasks relating to the operation of the security framework. For example, the SECURITY ADMIN role is associated with resource MODIFY_PROFILES, which allows for modification of roles and resources with which users are associated.

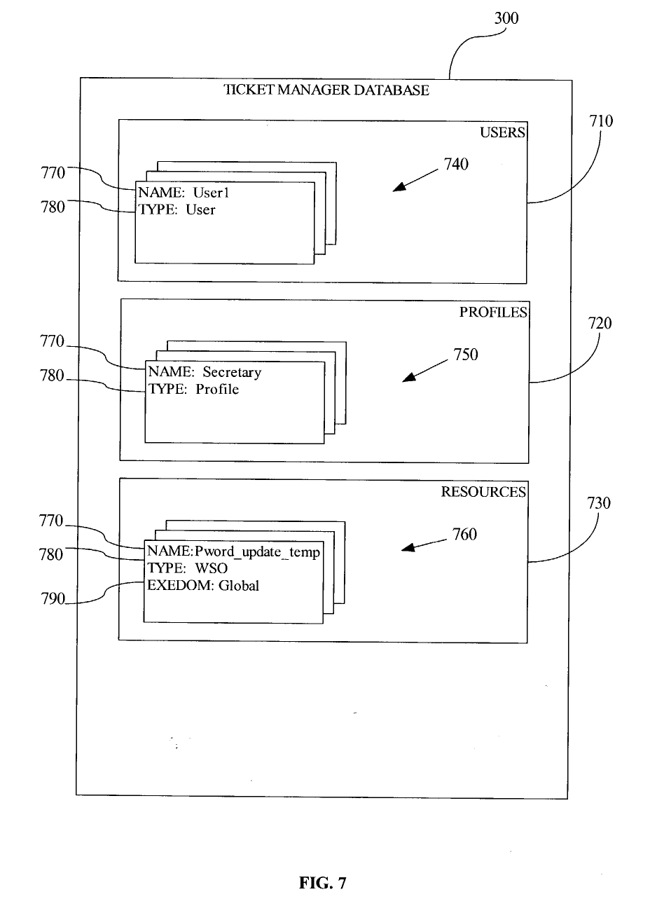

FIG. 7 shows the structure of the TM Master Database 300, which contains all of the information necessary to provide an organization's security structure. The database is logically divided into three parts: the user data 710, profile data 720, and resources data 730. The data contained in each of these parts may be stored in a single database or group of databases, as necessary to efficiently store the information. The database contains records, referred to herein as registers.

The user data portion 710 of the database generally contains at least one register 740 for each user. A user register 740 provides information relating to a particular user that cannot be generalized to a group or category of users, such as the roles and resources to which the user is assigned. The profile portion 720 of the database provides registers 750 relating to the roles or profiles into which the users are categorized, e.g., secretary, programmer, administrator, manager, etc. The resource portion 730 of the database contains a register 760 for each resource, which, as discussed above, is a set of parameters and/or data used by security modules to control access to information technology assets.

Each register contains certain fields, such as name, type, and execution domain. The name field 770 provides a unique identifier for the register within the user 710, profile 720 or resource 730 database, e.g., “User1”, “Secretary”, and “Pword_update_temp”. The type field 780 of a user 740 or profile 750 register categorizes the register into the respective part of the database (e.g., “user” or “profile”). The type field 780 of a resource register 760 contains the name of the security module with which the resource is used (e.g., Single Sign-on, Workflow, WSO, etc.). The execution domain (exedom) 790, which is discussed in further detail below, specifies a domain of the network within which the register is applicable, e.g., a particular directory or sub-directory of the network server in which the security module is authorized to use the data contained in the register. The exedom 790 may be specified as “global”, if the register is applicable in all domains. The user 740 and profile 750 registers generally do not specify an execution domain 790.

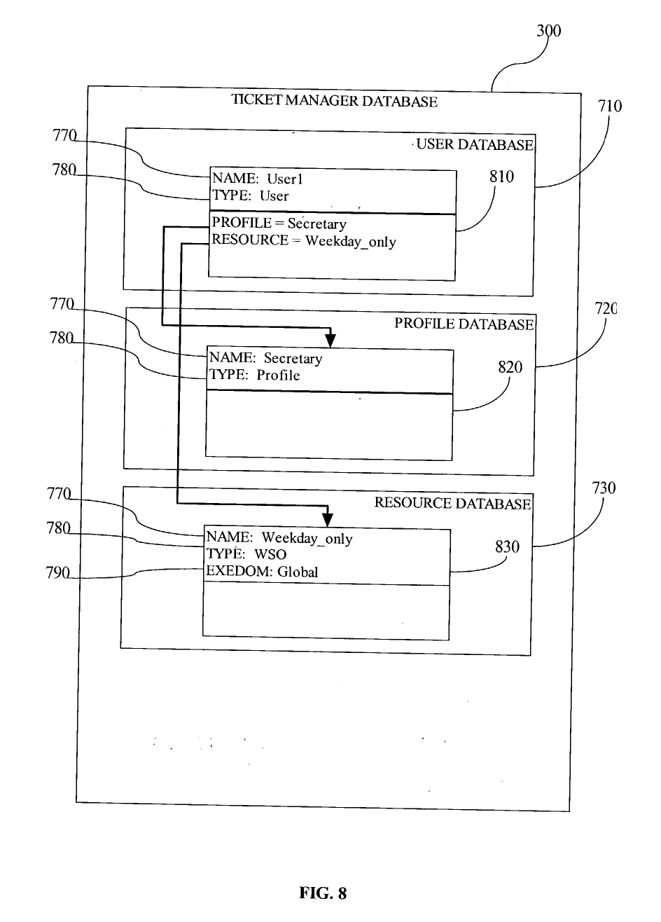

As shown in FIG. 8, for each user, the user database contains a register 810 having a name field 770 that corresponds to the username that the user enters to log on to the workstation, e.g., “User1”. The user's register 810 refers to all of the profile registers 750 (roles) and resource registers 760 that are associated with that user. The user's register 810 also may provide personal data, such as user password, date of password changes, and most recent session start time/date. Thus, the user's register 810 ties together all of the context information that is applicable to the user. A ticket is generated for a user by compiling all of the context information stored in or referred to by a user's register 810.

In the example of FIG. 8, the register 810 for “User1” refers to the profile register 820 named “Secretary”, which provides information relating to all users in that category. The user's register 810 may refer to as many profile registers 750 as necessary to fully define the user's security environment. The register 810 for “User1” also refers to a resource register 830 named “Weekday_only”, which may be, for example, a set of security parameters that restricts workstation access to weekdays only. A ticket generated for “User1” therefore would include all of the information stored in or referred to by the “Secretary” profile 820 and all of the parameters defined in the “Weekday_only” resource 830.

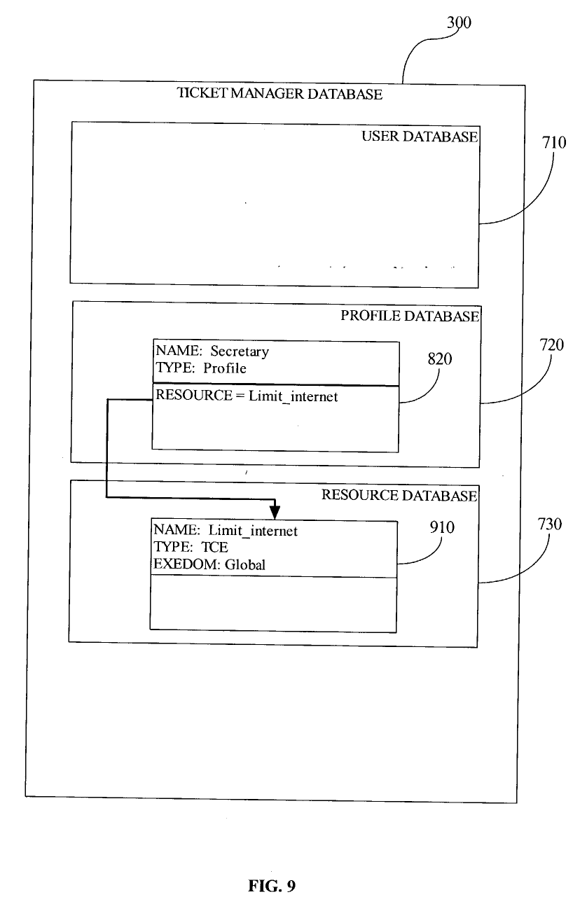

As shown in FIG. 9, a profile register named “Secretary” 820 is established to define a role relating to the secretarial staff of the organization. Profiles 750 may be associated with resources 760, which contain data and/or parameters that are used by the information security modules to establish the security environment. As discussed above, each resource is categorized by three fields: name, type, and execution domain (exedom). The type field indicates the security module with which the resource is associated, e.g., Single Sign-on, WSO, ICE, Croxy, or Workflow, and the name field uniquely identifies the resource within each type. In this example, the “Secretary” profile 820 refers to a resource named “Limit_Internet” 910, which contains a set of parameters that limits access to the Internet using the ICE security module 230. This example illustrates how a security policy-related resource may be associated with a role or profile to define a security policy that is meant to apply to a particular category of users.

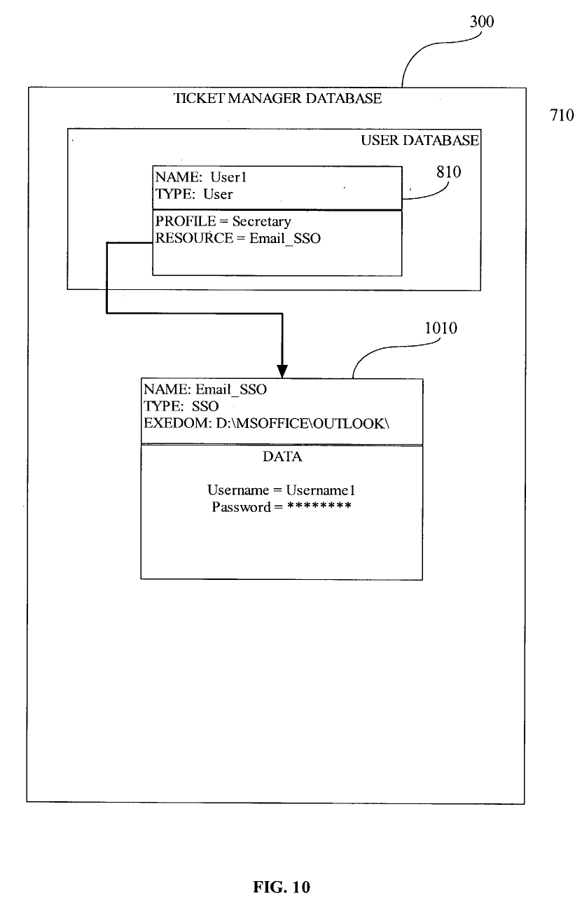

FIG. 10 shows an example of a user register that refers directly to a resource. The register 810 for Username 1 refers to a resource 1010 named “Email_SSO”, which is defined as type “SSO”, because it is used by the Single Sign-on Module 250. The execution domain is defined as the directory on the network server from which the email application is executed, and it is within this specified execution domain that the Single Sign-on Module is authorized to use the data contained in the resource. In this example, the resource 1010 contains the username and password data that are used by Single Sign-on Module 250 to authenticate the user to the email application. All of the security policy-related resources assigned to a user, either directly or through a profile, are compiled by the TM Server 130 when it generates a ticket for the user. These security policies take effect when the constituent policy-related resources are delivered to and implemented by an information security module, e.g., the ICE Module.

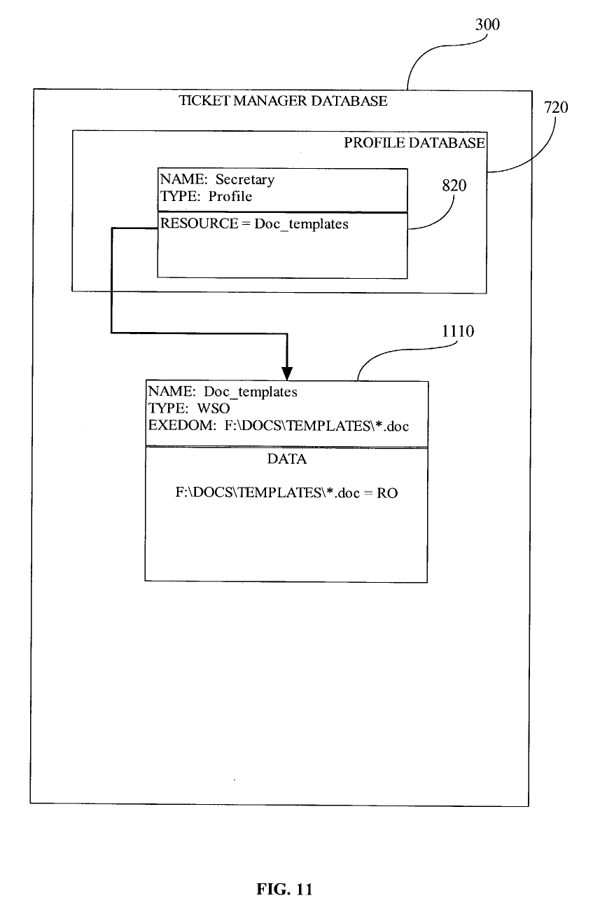

FIG. 11 shows another example of a profile register that refers to a resource. The profile 820 “Secretary” refers to a resource 1110 named “Doc_templates”, which provides data for use by the WSO Workstation Access Control Module 240. Based on this data, the WSO Module 240 establishes read-only access to a directory on a network server drive that is to be used for document templates. This access control is applied to all users in the “Secretary” profile 820. Other profiles may refer to this resource 1110 as well. In addition, other users may be given a different level of access for this directory by other resources. For example, a document administrator may be associated with a resource that provides read/write access to this directory so that the documents it contains can be modified.

As discussed above, the execution domain field defines a domain within which a resource is applicable, e.g., a particular directory of the network server. The capability of defining resources in terms of execution domains allows the development of a security environment in which user access can be defined in terms of the user and the application. In such an environment, various applications run by a user on the user's workstation may have access to different directories on the network server and different network hardware resources.

In a conventional access control model, a user is assigned a set of permissions that define the information technology assets that can be accessed. For example, under conventional file system access control, when a user attempts to open a file, the operating system checks the user's permissions to access that file, and different users may have different permissions, e.g., read, write, execute, etc. In this conventional access control model, which may be referred to as a User-Resource (U-R) Model, each User has a unique access relationship to a given information technology asset that is defined by the access control rules or permissions.

By contrast, the definition of an execution domain creates a new kind of relationship between a user and the information technology (IT) assets. This relationship is mediated by the application or process through which the user is trying to access the IT asset, because access to the resource is only authorized using the applications or processes in the defined execution domain. Thus, a User-Application-Resource (U-A-R) relationship is created in which each user can have a different set of permissions for each application or process. For example, a user may be able to access a certain “.doc” file using Microsoft Word™ but not using WordPerfect™. As a further example, a user may be able to access a certain directory only using Microsoft Excel™.

Under the U-A-R Model, execution domains are defined by the set of permissions applied at a particular time depending upon the application that is being executed. The execution domain can change whenever a new application is executed or whenever certain specific actions are triggered by a running application. This leads to a great deal of flexibility in defining the security environment, which results in significant advantages over conventional approaches.

For example, by defining execution domains to be applied by the WSO and Croxy Modules, it is possible to restrict users to using a particular application to access a database. This prevents users from accessing the database with unapproved applications, e.g., a database browser, and modifying or stealing information. It also ensures that access to the database is subject to the various security features of the database application. For example, the database application may hide certain fields from users or permit read-only access to certain portions of the database. Furthermore, the database administrator can be given permission to change data in the database using an administration program, but prohibited from changing the permission levels of other users. Similarly, the security administrator can be given permission to change the permission levels of other users, but not to change data in the database.

It is also possible to prevent users from accessing the network while a modem is being used by the workstation. Conversely, the user may be prevented from using the modem while accessing the network. A security environment defined in this manner prevents users from transferring large quantities of data from the network to an outside host and prevents the network's firewall and auditing capabilities from being bypassed.

As a further example, by defining execution domains to be applied by the WSO and ICE Modules, it is possible to control transactions that occur outside of authorized applications. Specifically, network transactions that occur outside certain predetermined applications can be recorded using the ICE Module, and control mechanisms can be applied using the WSO Module depending on, e.g., the appearance of certain text strings.

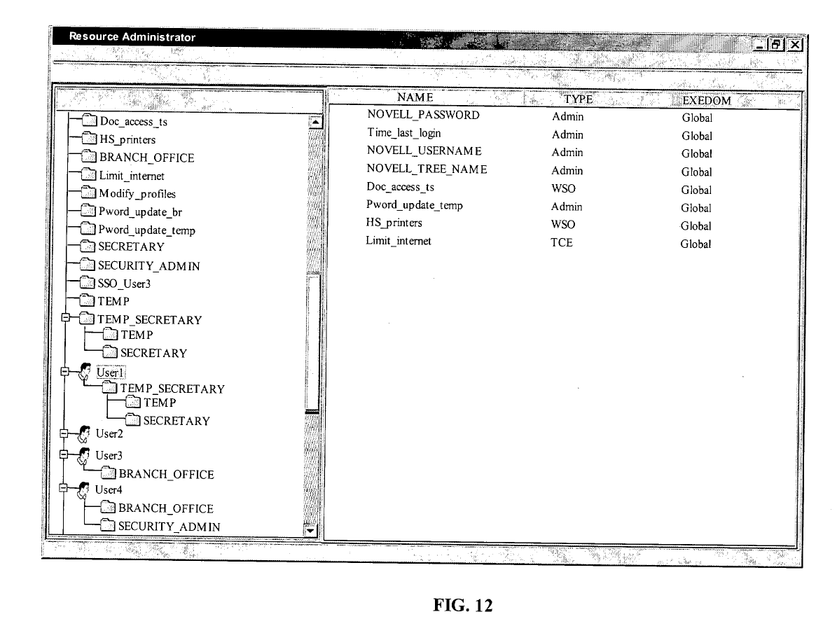

As shown in FIG. 12, the TM Master Database is controlled using the Resource Administrator, which is a graphical user interface. The Resource Administrator arranges all the user and profile registers in a hierarchical display similar to a file directory tree. The resources associated with each user or profile may be viewed by clicking on it. The user or profile is highlighted and the resources associated with it are shown in the window to the right. The listing shows the name, type (the module with which it interacts), and execution domain. Initially, each user and profile register appears as an entry on the root level of the tree. User registers then may be associated with the profile registers. The association may be created, for example, by dragging the profile register with the pointing device and dropping it on a user register. This operation copies the profile in question and attaches it as a branch from the user register (leaving the original profile register in the root level). For example, User1 is associated with the profiles TEMP and TEMP_SECRETARY. In order to access the TM Master Database to perform such modifications, the user must be associated with resources that grant access to the database, e.g., MODIFY_PROFILES. This allows the designation of a TM Master Database administrator or administrators, who may be different from the system administrator.

The Resource Administrator also allows user, profile, and resource registers to be created using a series of editors, each of which is configured to create a particular type of register. For example, a user register editor may be provided to allow creation of user registers and would allow personal user data, such as passwords, to be entered. The user register editor may also allow the user to be associated with profiles. To create resources, a separate editor may be provided for each security module for which the resources may be created. For example, a WSO module editor may be provided to allow creation of resources that contain data to be used by the WSO module, such as shown in the example of FIG. 11.

As discussed above with respect to FIG. 4, after the user logs on, a connection is established to the TM Server, and the TM Client requests a ticket for the user. To generate the ticket, the TM Server searches the TM Master Database for a register for the user who is logging on. The register is separated into the resources and profiles with which the user is associated. The resources are added to the user's ticket. The profiles are added to a local tree that resembles the entry for the user on the Resource Administrator screen, which has branches and sub-branches for the various profiles with which the user is associated. For example, as shown in FIG. 12, User1 has a branch for the profile TEMP_SECRETARY, which in turn has sub-branches TEMP and SECRETARY. The local tree is traversed using a breadth-first search algorithm, under which the resources associated with each profile are added to the user's ticket starting at the first branch level of the local tree and proceeding to the sub-branch levels. Thus, the resulting ticket is a list of all resources associated with the user. The ticket is digitally signed by the TM Server and circulated as described previously.

It will be appreciated that each of these embodiments discussed above provides a novel system and method for providing a security framework that allows information security modules to interact with one another to provide a systematic, integrated information security solution.

It also will be appreciated that because all of the user's security data is stored, updated, circulated, and authenticated by the Ticket Management Sub-system, and this information is circulated to all of the information security modules, the invention provides a multi-layered, integrated system that is less vulnerable to certain types of attacks than conventional approaches.

It also will be appreciated that because access to information technology assets can be defined in terms of an execution domain, a dynamic security environment is provided that allows information technology assets to be protected in a more flexible and more intelligent manner than conventional approaches, thus providing a greater overall level of security and permitting the enforcement of a proactive security policy in accordance with proactive security strategies.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims.

What is claimed is:

1. A system for controlling access to information technology assets in a computer network, the system comprising:
a ticket manager server configured to generate tickets based on user data in a master database; and
a ticket manager client resident on a workstation, the client being configured to receive tickets from the ticket manager server and distribute resource data obtained from the tickets to network security modules,
wherein the user data comprises at least one resource register, each resource register including:
a type field designating a specific one of the security modules;
resource data for use by the designated security module; and
an execution domain field designating an exclusive execution environment in which the designated security module can use the resource data.

2. The system of claim 1, wherein the user data further comprises:
user registers, each user register corresponding to a user; and
profile registers, each profile register corresponding to one or more users,
wherein the system allows each user register and each profile register to be associated with one or more resource registers.

3. The system of claim 1, wherein the ticket manager server generates a ticket for a user by a method comprising the steps of:
searching the master database for a register for the user;
separating the register into resource references and profile references;
adding the referenced resources to the ticket;
adding the referenced profiles to a local tree; and
traversing the local tree using a breadth-first search algorithm, under which the resources associated with each profile are added to the ticket starting at a first branch level of the local tree and proceeding to sub-branch levels, if any.

4. The system of claim 1, wherein the designated security module is a module for providing single sign-on capability, and the resource data comprises user password data.

5. The system of claim 1, wherein the designated security module is a module for establishing logical access control for information stored in the computer network, and the resource data comprises file access parameters.

6. The system of claim 1, wherein the designated security module is a module for providing encrypted communication between components of the computer network, and the resource data comprises encryption configuration information.

7. The system of claim 1, wherein the designated security module is a module for controlling a computer network administrative procedure by defining nodes that represent steps that are performed in the procedure, and the resource data comprises a designated type of user that is authorized to complete each node.

8. The system of claim 1, wherein the designated security module is a module for controlling generation of a network log, and the resource data comprises parameters relating to criteria for logging information and users to be included in the log.

9. The system of claim 1, wherein the designated security module is a module for providing content-based control over transactions in the computer network, and the resource data comprises parameters relating to criteria for network transactions that are to be controlled.

10. A system for controlling access to information technology assets in a computer network, the system comprising:
a ticket manager server configured to generate tickets based on user data in a master database; and
a ticket manager client resident on a workstation, the client being configured to receive tickets from the ticket manager server and distribute resource data obtained from the tickets to network security modules,
wherein the user data comprises:
at least one resource register providing resource data for use by the security modules;
at least one user register, each user register corresponding to a user; and
at least one profile register, each profile register corresponding to one or more users;
wherein the system allows each user register and each profile register to be associated with one or more resource registers.

11. The system of claim 10, wherein the ticket manager server generates a ticket for a user by a method comprising the steps of:
searching the master database for a register for the user;
separating the register into resource references and profile references;
adding the referenced resources to the ticket;
adding the referenced profiles to a local tree; and
traversing the local tree using a breadth-first search algorithm, under which the resources associated with each profile are added to the ticket starting at a first branch level of the local tree and proceeding to sub-branch levels, if any.

12. The system of claim 10, wherein each resource register comprises a type field designating a specific one of the security modules for which the resource data of the resource register is configured to be used.

13. The system of claim 12, wherein each resource register further comprises an execution domain field that exclusively designates an execution environment in which the designated security module can use the resource data.

14. A system for controlling access to information technology assets in a computer network, the system comprising:
a ticket manager server configured to generate tickets based on user data in a master database;
a plurality of ticket manager clients, each resident on one of a plurality of workstations, the clients being configured to receive tickets from the ticket manager server and distribute resource data obtained from the tickets to network security modules;
a plurality of local ticket manager slave databases, each resident on one of the workstations, and configured to receive a copy of each of the tickets sent to a corresponding one of the ticket manager clients; and
a global ticket manager slave database configured to receive a copy of each of the tickets sent to the ticket manager clients.

15. The system of claim 14, further comprising a mirror ticket manager server configured to generate tickets based on user data in a mirror database that is periodically copied from the master database of the ticket manager server.

16. A system for controlling access to information technology assets in a computer network, the system comprising:
means for generating tickets based on user data in a master database of a ticket manager server, the user data including resource registers, each resource register including a type field designating a specific one of the security modules and resource data for use by the designated security module;
means for sending tickets from the ticket manager server to a ticket manager client resident on a workstation;
means for distributing resource data obtained from the tickets to network security modules; and
means for designating an exclusive execution domain field that defines an execution environment in which the designated security module can use the resource data.

17. The system of claim 16, wherein the user data further includes user registers that each correspond to a user and profile registers that each correspond to one or more users, the method further comprising the step of associating each user register and each profile register with one or more resource registers.

18. The system of claim 16, further comprising:
means for searching the master database of the ticket manager server for a user register for the user;
means for separating the user register into resource references and profile references;
means for adding the referenced resources to the ticket;
means for adding the referenced profiles to a local tree; and
means for traversing the local tree using a breadth-first search algorithm, under which the resources associated with each profile are added to the ticket starting at a first branch level of the local tree and proceeding to sub-branch levels, if any.

19. A system for controlling access to information technology assets in a computer network, the system comprising:
means for generating tickets based on user data in a master database of a ticket manager server, the user data including resource registers providing resource data for use by the security modules, user registers that each correspond to a user, and profile registers that each correspond to one or more users;
means for sending tickets from the ticket manager server to a ticket manager client resident on a workstation;
means for distributing resource data obtained from the tickets to network security modules; and
means for associating each user register and each profile register with one or more resource registers.

20. The system of claim 19, further comprising:
means for searching the master database of the ticket manager server for a user register for the user;
means for separating the user register into resource references and profile references;
means for adding the referenced resources to the ticket;
means for adding the referenced profiles to a local tree; and
means for traversing the local tree using a breadth-first search algorithm, under which the resources associated with each profile are added to the ticket starting at a first branch level of the local tree and proceeding to sub-branch levels, if any.

21. The system of claim 19, wherein each resource register comprises a type field designating a specific one of the security modules for which the resource data of the resource register is configured to be used.

22. The system of claim 19, wherein each resource register further comprises an execution domain field that exclusively designates an execution environment in which the designated security module can use the resource data.

23. Computer code for controlling access to information technology assets in a computer network, the computer code comprising:
code for generating tickets based on user data in a master database of a ticket manager server, the user data including resource registers, each resource register including a type field designating one of the security modules and resource data for use by the designated security module;
code for sending tickets from the ticket manager server to a ticket manager client resident on a workstation;
code for distributing resource data obtained from the tickets to network security modules; and
code for designating an exclusive execution domain field that defines an execution environment in which the designated security module can use the resource data.

24. The computer code of claim 23, wherein the user data further includes user registers that each correspond to a user and profile registers that each correspond to one or more users, the computer code further comprising code for associating each user register and each profile register with one or more resource registers.

25. A method for controlling access to information technology assets in a computer network, the method comprising the steps of:
generating tickets based on user data in a master database of a ticket manager server, the user data including resource registers, each resource register including a type field designating a specific one of the security modules and resource data for use by the designated security module;
sending tickets from the ticket manager server to a ticket manager client resident on a workstation;
distributing resource data obtained from the tickets to network security modules; and
designating an exclusive execution domain field that defines an execution environment in which the designated security module can use the resource data.

26. The method of claim 25, wherein the user data further includes user registers that each correspond to a user and profile registers that each correspond to one or more users, the method further comprising the step of associating each user register and each profile register with one or more resource registers.

27. The method of claim 25, further comprising the steps of:
searching the master database of the ticket manager server for a user register for the user;
separating the user register into resource references and profile references;
adding the referenced resources to the ticket;
adding the referenced profiles to a local tree; and
traversing the local tree using a breadth-first search algorithm, under which the resources associated with each profile are added to the ticket starting at a first branch level of the local tree and proceeding to sub-branch levels, if any.

28. A method for controlling access to information technology assets in a computer network, the method comprising the steps of:
generating tickets based on user data in a master database of a ticket manager server, the user data including resource registers providing resource data for use by the security modules, user registers that each correspond to a user, and profile registers that each correspond to one or more users;
sending tickets from the ticket manager server to a ticket manager client resident on a workstation;
distributing resource data obtained from the tickets to network security modules; and
associating each user register and each profile register with one or more resource registers.

29. The method of claim 28, further comprising the steps of:
searching the master database of the ticket manager server for a user register for the user;
separating the user register into resource references and profile references;
adding the referenced resources to the ticket;
adding the referenced profiles to a local tree; and
traversing the local tree using a breadth-first search algorithm, under which the resources associated with each profile are added to the ticket starting at a first branch level of the local tree and proceeding to sub-branch levels, if any.

30. The method of claim 28, wherein each resource register comprises a type field designating a specific one of the security modules for which the resource data of the resource register is configured to be used.

31. The method of claim 28, wherein each resource register further comprises an execution domain field that exclusively designates an execution environment in which the designated security module can use the resource data.

32. A method for controlling access to information technology assets in a computer network, the method comprising the steps of:
generating tickets based on user data in a master database of a ticket manager server;
sending tickets from the ticket manager server to a plurality of ticket manager clients, each resident on one of a plurality of workstations,
distributing resource data obtained from the tickets to network security modules;
receiving a copy of each of the tickets sent to each of the ticket manager clients in a corresponding local ticket manager slave database resident on the workstation; and
receiving, in a global ticket manager slave database, a copy of each of the tickets sent to the ticket manager clients.

33. The method of claim 32, further comprising the step of generating tickets in a mirror ticket manager server based on user data in a mirror database that is periodically copied from the master database of the ticket manager server.

34. A method for controlling access to information technology assets in a computer network, the method comprising the steps of:
receiving a ticket request at a ticket manager server, the ticket manager server having user data in a master database;
creating a ticket for the user containing resource data for use by network security modules;
retrieving from the master database a user register corresponding to the user;
determining whether the user register refers to any resource registers;
if the user register refers to any resource registers, retrieving the referenced resource registers from the master database and adding any resource data in the retrieved resource registers to the ticket; and
outputting the ticket from the ticket manager server in accordance with the ticket request.

35. The method of claim 34, further comprising the steps of:
determining whether the user register refers to any profile registers;
if the user register refers to any profile registers, retrieving the referenced profile registers from the master database;
determining whether each of the referenced profile registers refers to any resource registers; and
retrieving the resource registers referenced by the profile registers from the master database and adding any resource data in the retrieved resource registers referenced by the profile registers to the ticket.

36. The method of claim 35, further comprising the steps of:
determining whether each of the referenced profile registers refers to any sub-profile registers;
if the profile registers refer to any sub-profile registers, retrieving the sub-profile registers from the master database;
determining whether each of the referenced sub-profile registers refers to any resource registers; and
retrieving the resource registers referenced by the sub-profile registers from the master database and adding any resource data in the retrieved resource registers referenced by the sub-profile registers to the ticket.

37. A method for controlling access to information technology assets in a computer network, the method comprising the steps of:
requesting a ticket from a ticket manager server;
generating a ticket by retrieving from a master database a user register corresponding to a user, retrieving any referenced resource registers, and adding any resource data in the retrieved resource registers to the ticket;
sending the ticket to a ticket manager client in a workstation; and
retrieving the resource data from the ticket and distributing the resource data to network security modules.

38. The method of claim 37, further comprising the steps of:
adding updated resource data to the ticket in the ticket manager client;
sending the updated ticket to the ticket manager server; and
retrieving the updated resource data from the ticket and storing the updated resource data in the master database.

39. The method of claim 37, further comprising the steps of:
digitally signing the ticket after generating the ticket; and
authenticating the ticket after the ticket is received by the ticket manager client.

40. The method of claim 37, wherein one of the security modules provides single sign-on capability, and the resource data comprises user password data.

41. The method of claim 37, wherein one of the security modules establishes logical access control for information stored in the computer network, and the resource data comprises file access parameters.

42. The method of claim 37, wherein one of the security modules provides encrypted communication between components of the computer network, and the resource data comprises encryption configuration information.

43. The method of claim 37, wherein one of the security module controls a computer network administrative procedure by defining nodes that represent steps that are performed in the procedure, and the resource data comprises a designated type of user that is authorized to complete each node.

44. The method of claim 37, wherein the designated security module is a module for controlling generation of a network log, and the resource data comprises parameters relating to criteria for logging information and users to be included in the log.

45. The method of claim 37, wherein the designated security module is a module for providing content-based control over transactions in the computer network, and the resource data comprises parameters relating to criteria for network transactions that are to be controlled.

46. The computer code of claim 23, further comprising:
code for searching the master database of the ticket manager server for a user register for the user;
code for separating the user register into resource references and profile references;
code for adding the referenced resources to the ticket;
code for adding the referenced profiles to a local tree; and
code for traversing the local tree using a breadth-first search algorithm, under which the resources associated with each profile are added to the ticket starting at a first branch level of the local tree and proceeding to sub-branch levels, if any.

47. Computer code for controlling access to information technology assets in a computer network, the computer code comprising:
code for generating tickets based on user data in a master database of a ticket manager server, the user data including resource registers providing resource data for use by the security modules, user registers that each correspond to a user, and profile registers that each correspond to one or more users;
code for sending tickets from the ticket manager server to a ticket manager client resident on a workstation;
code for distributing resource data obtained from the tickets to network security modules; and
code for associating each user register and each profile register with one or more resource registers.

48. The computer code of claim 47, further comprising:
code for searching the master database of the ticket manager server for a user register for the user;
code for separating the user register into resource references and profile references;
code for adding the referenced resources to the ticket;
code for adding the referenced profiles to a local tree; and
code for traversing the local tree using a breadth-first search algorithm, under which the resources associated with each profile are added to the ticket starting at a first branch level of the local tree and proceeding to sub-branch levels, if any.

49. The computer code of claim 47, wherein each resource register comprises a type field designating a specific one of the security modules for which the resource data of the resource register is configured to be used.

50. The computer code of claim 47, wherein each resource register further comprises an execution domain field that exclusively designates an execution environment in which the designated security module can use the resource data.

51. Computer code for controlling access to information technology assets in a computer network, the computer code comprising:
code for generating tickets based on user data in a master database of a ticket manager server;
code for sending tickets from the ticket manager server to a plurality of ticket manager clients, each resident on one of a plurality of workstations,
code for distributing resource data obtained from the tickets to network security modules;
code for receiving a copy of each of the tickets sent to each of the ticket manager clients in a corresponding local ticket manager slave database resident on the workstation; and
code for receiving, in a global ticket manager slave database, a copy of each of the tickets sent to the ticket manager clients.

52. The computer code of claim 51, further comprising code for generating tickets in a mirror ticket manager server based on user data in a mirror database that is periodically copied from the master database of the ticket manager server.

53. Computer code for controlling access to information technology assets in a computer network, the computer code comprising:
code for receiving a ticket request at a ticket manager server, the ticket manager server having user data in a master database;
code for creating a ticket for the user containing resource data for use by network security modules;
code for retrieving from the master database a user register corresponding to the user;
code for determining whether the user register refers to any resource registers;
code for, if the user register refers to any resource registers, retrieving the referenced resource registers from the master database and adding any resource data in the retrieved resource registers to the ticket; and
code for outputting the ticket from the ticket manager server in accordance with the ticket request.

54. The computer code of claim 53, further comprising:
code for determining whether the user register refers to any profile registers;
code for, if the user register refers to any profile registers, retrieving the referenced profile registers from the master database;
code for determining whether each of the referenced profile registers refers to any resource registers; and
code for retrieving the resource registers referenced by the profile registers from the master database and adding any resource data in the retrieved resource registers referenced by the profile registers to the ticket.

55. The computer code of claim 54, further comprising:
code for determining whether each of the referenced profile registers refers to any sub-profile registers;
code for, if the profile registers refer to any sub-profile registers, retrieving the sub-profile registers from the master database;
code for determining whether each of the referenced sub-profile registers refers to any resource registers; and
code for retrieving the resource registers referenced by the sub-profile registers from the master database and adding any resource data in the retrieved resource registers referenced by the sub-profile registers to the ticket.

56. Computer code for controlling access to information technology assets in a computer network, the computer code comprising:
code for requesting a ticket from a ticket manager server;
code for generating a ticket by retrieving from a master database a user register corresponding to a user, retrieving any referenced resource registers, and adding any resource data in the retrieved resource registers to the ticket;
code for sending the ticket to a ticket manager client in a workstation; and
code for retrieving the resource data from the ticket and distributing the resource data to network security modules.

57. The computer code of claim 56, further comprising:
code for adding updated resource data to the ticket in the ticket manager client;
code for sending the updated ticket to the ticket manager server; and
code for retrieving the updated resource data from the ticket and storing the updated resource data in the master database.

58. The computer code of claim 56, further comprising:
code for digitally signing the ticket after generating the ticket; and
code for authenticating the ticket after the ticket is received by the ticket manager client.

59. The computer code of claim 56, wherein one of the security modules provides single sign-on capability, and the resource data comprises user password data.

60. The computer code of claim 56, wherein one of the security modules establishes logical access control for information stored in the computer network, and the resource data comprises file access parameters.

61. The computer code of claim 56, wherein one of the security modules provides encrypted communication between components of the computer network, and the resource data comprises encryption configuration information.

62. The computer code of claim 56, wherein one of the security module controls a computer network administrative procedure by defining nodes that represent steps that are performed in the procedure, and the resource data comprises a designated type of user that is authorized to complete each node.

63. The computer code of claim 56, wherein the designated security module is a module for controlling generation of a network log, and the resource data comprises parameters relating to criteria for logging information and users to be included in the log.

64. The computer code of claim 56, wherein the designated security module is a module for providing content-based control over transactions in the computer network, and the resource data comprises parameters relating to criteria for network transactions that are to be controlled.
